(19) United States
(12) Patent Application Publication
(10) Pub. No.: US 2012/0096997 A1
(43) Pub. Date: Apr. 26, 2012

(54) Apparatus for Tightening a Threaded Fastener

(75) Inventors: Rod Corbett, West Midlands (GB); Michael Jones, West Midlands (GB); John J Junkers, Saddle River, NJ (US); Peter Koppenhoefer, Portland, PA (US)

(73) Assignees: JAMES WALKER ROTABOLT LIMITED, Woking Surrey (GB); HYTORC DIVISION UNEX CORPORATION, Mahwah, NJ (US)

(21) Appl. No.: 13/380,263

(22) PCT Filed: Jun. 26, 2009
(86) PCT No.: PCT/US2009/048395

§ 371 Date: Dec. 22, 2011

(51) Int. Cl. B25B 23/14; B25B 23/157

(52) U.S. Cl. 81/473; 81/478

(57) ABSTRACT

An apparatus for tightening a threaded fastener of the kind having: a shank with an axial bore; a gauge pin positioned in the bore and connected to the shank, a part of the gauge pin either protruding from, flush with, or recessed from an end face of the fastener; and an indicating member rotatably supported on the either protruding from, flush with, or recessed from part of the gauge pin, the indicating member being arranged such that it is free to rotate when the fastener is unstressed but when the fastener is subjected to a predetermined tensile load the indicating member is held against rotation, wherein the fastener has either a head connected to an end of the shank adjacent the indicating member or, alternatively, has a nut which is threadedly engageable with an end of the shank adjacent the indicating member; the apparatus including: a receiving member, rotatably supported in the apparatus, for receiving the head connected to or for receiving a nut engageable with the shank; a device for effecting rotation of the receiving member; an engaging member, rotatably supported in the apparatus, and being configured such that, in use, it is fixed rotationally relative to the indicating member; wherein the apparatus includes a device for sensing a predetermined resistance to rotation of the engaging member.

### DESCRIPTION OF INVENTION

This invention relates to an apparatus for tightening a threaded fastener. More particularly, this invention relates to an apparatus for tightening a threaded fastener which includes means for indicating a, usually tensional, load to which the fastener is subjected.

The apparatus has been devised primarily for use with fasteners of the kind having a shank with an axial bore; a gauge pin positioned in the bore and connected to the shank, a part of the gauge pin protruding outwards beyond an end face of the fastener; and an indicating member rotatably supported on the protruding part of the gauge pin, the indicating member being arranged such that it is free to rotate when the fastener is unstressed but when the fastener is subjected to a predetermined tensile load the indicating member is held against rotation by contact with a part of the fastener. The fastener has either a head connected to an end of the shank adjacent the indicating member (e.g. what is known in the art as a ‘screw’) or, alternatively, has a nut which is threadedly engageable with an end of the shank adjacent the indicating member (e.g. what is known in the art as a ‘stud and nut combination’).

The gauge pin and indicating member are usually set with an initial gap between the indicating member and the end face of the fastener such that the gap is closed when the fastener is subjected to the predetermined tensile load (due to an elongation of the fastener under said load) and the end face bears against the indicator member sufficiently to prevent it from being rotated, for example, by the hand of a user.

When a power tool is used to tighten such a fastener a user must check the indicating member at frequent intervals during tightening of the fastener, to ensure that the fastener is not over-tightened. Having to manually check the indicating member at such intervals has the disadvantage of increasing the time taken to tighten each fastener. Moreover, during tightening of the fastener, there is nothing to indicate to the user whether the fastener has been over-tightened.

The present invention has therefore been devised to address these issues.

According to a first aspect of the invention we provide an apparatus for tightening a threaded fastener of the kind having: a shank with an axial bore; a gauge pin positioned in the bore and connected to the shank, a part of the gauge pin either protruding from, flush with or recessed from an end face of the fastener; and an indicating member rotatably supported on the either protruding from, flush with or recessed from part of the gauge pin, the indicating member being arranged such that it is free to rotate when the fastener is unstressed but when the fastener is subjected to a predetermined tensile load the indicating member is held against rotation, wherein the fastener has either a head connected to the shank or, alternatively, has a nut which is threadedly engageable with the shank; the apparatus including: a receiving member, rotatably supported in the apparatus, for receiving the head connected to fastener or for receiving a nut engageable with the shank; a device for effecting rotation of the receiving member; an engaging member, rotatably supported in the apparatus, and being configured such that, in use, it is fixed rotationally relative to the indicating member; wherein the apparatus includes a device for sensing a predetermined resistance to rotation of the engaging member.

Further features of the invention are set out in claims 2 to 46 appended hereto.

The invention will now be described by way of example only with reference to the accompanying drawings, of which:

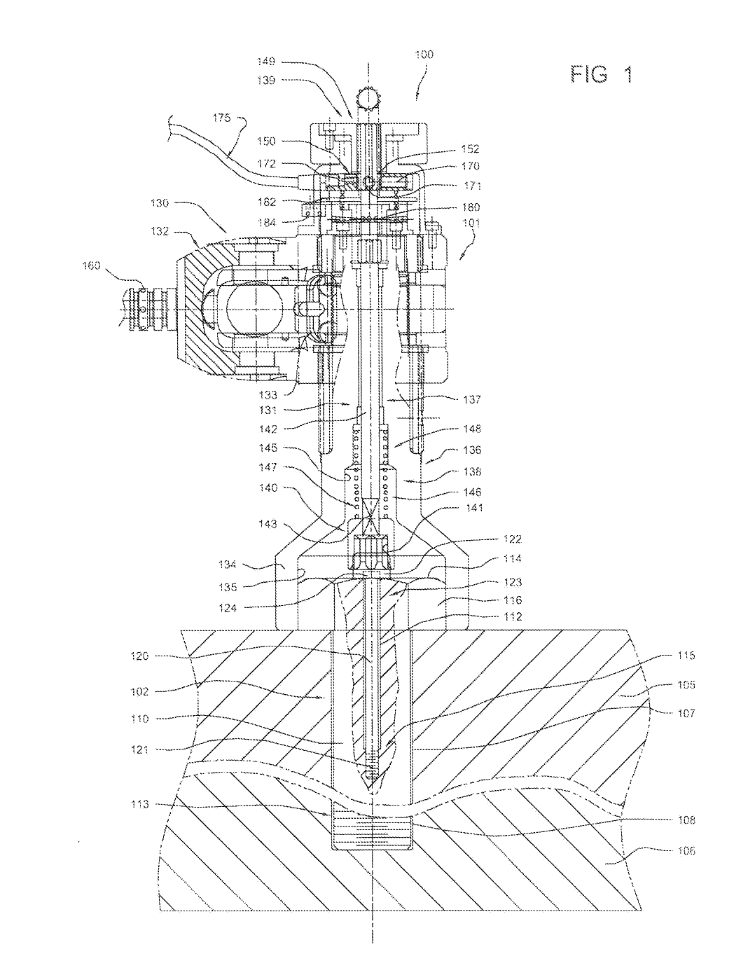

FIG. 1 is a side, cross-sectional view, of a first embodiment of the present invention; and

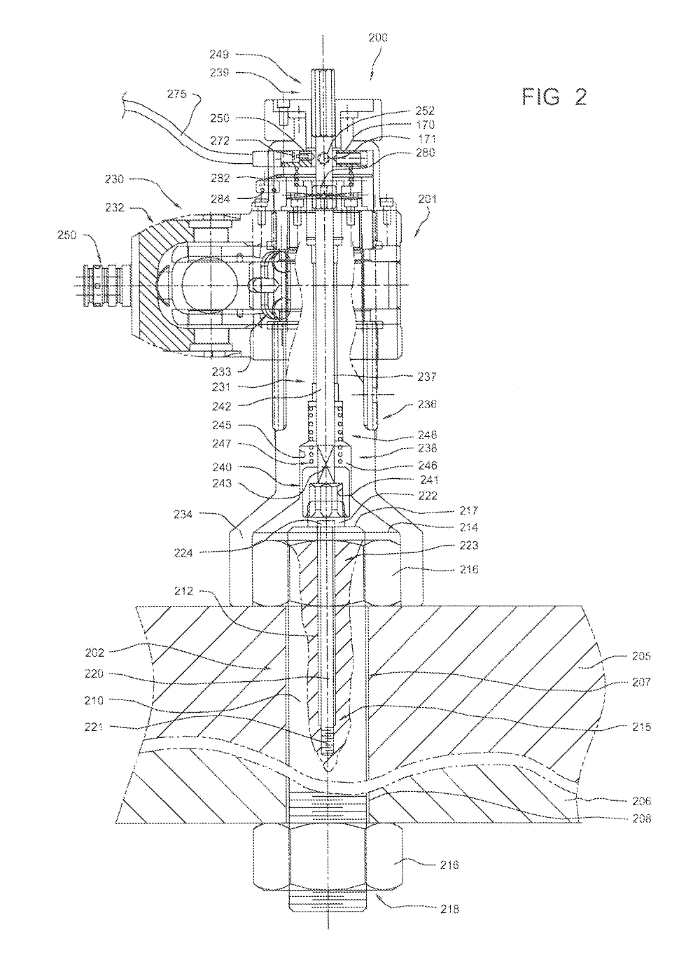

FIG. 2 is a side, cross-sectional view, of a second embodiment of the present invention.

Referring to FIG. 1, this shows a first embodiment of an apparatus 101 for tightening a load indicating fastener 102. The apparatus 101 may be used to fasten members together, such as flat members 105 and 106, which are fastened in face-to-face relation by fastener 102, commonly known in the art as a ‘screw’. A head 111 of fastener 102 is adjacent to an exposed face of flat member 105. The head 111 may act on flat member 105 via a washer.

Generally, fastener 102 is of the kind having at least a partially hollow shank 110; a gauge pin 120 in the shank 110; and an indicating member 122 rotatably supported on gauge pin 120. The indicating member 122 is rotatable when the fastener 102 is unstressed and substantially non-rotatable when the fastener 102 is subjected to a predetermined tensile load. Specifically, the fastener 102 has a shank 110 and a head 111, with an axial bore 112 extending from the head 111 towards an end portion 113 of the shank 110. The fastener 102 includes a gauge pin 120 positioned in the axial bore 112 and connected to the shank 110 by a threaded lower portion 121 inside the axial bore 112, towards a lower portion 115 thereof. The part 124 of an upper portion 123 of the gauge pin 120 protrudes outwards beyond an end face 114 of the head 111. The protruding part 124 rotatably supports an indicating member 122. The indicating member 122 is arranged such that it is free to rotate when the fastener 102 is unstressed but when the fastener 102 is subjected to a predetermined tensile load (i.e. once it has been tightened to a required load) the indicating member 122 is held against rotation by contact with the end face 114, as a result of the fastener 102 elongating under the tensional load. Thus, the indicating member 122 indicates to a user whether the fastener 102 has been fully tightened.

The apparatus 101 has a housing 130 which rotatably supports a drive axle 131. The drive axle 131 is rotatable by a hydraulically operated cylinder portion 132, which effects rotation to drive axle 131 by a lever ratchet mechanism 133. Hydraulic fluid, under pressure, is delivered to the apparatus 101 via a conduit 160 from an hydraulic pump (not shown).

Connected to a lower, and free, end portion 138 of the drive axle 131 is a receiving member 134 for receiving the head 111 of the fastener 102. The receiving member 134, commonly known in the art as a ‘socket’, is shaped so that it corresponds to the shape of the head 111. Once the head 111 is received, it and the receiving member 134 are rotationally fast with each other. It will be appreciated by those skilled in the art that there are many shapes the head 111 may be, and an appropriately shaped receiving member 134 must be selected for use with a particular fastener 102. Thus, as will be apparent from FIG. 1, the receiving member 134 is removably connectable to a driving element 136 of the drive axle 131 to permit interchangeability of differently shaped receiving members.

The apparatus 101 also includes an engaging member 140, which is rotatably, extensibly and retractably supported on a lower end portion 148 of an engaging axle 142 for receiving the indicating member 122. The engaging axle 142 is concentric and coaxial with and extends through an axial aperture 137 in the drive axle 131. The engaging member 140 is extensible and retractable from a recess 135 in the receiving member 134 through portions of the axial aperture 137 to a recess 145 in a bearing 146 by a downwardly biased compression spring 143 on the lower end portion 148.

The engaging member 140 has a recess 141 which is shaped so that is corresponds to the shape of the indicating member 122. Once the indicating member 122 is received in the recess 141, the indicating member 122 and the engaging member 140 are rotationally fast with each other. It will be appreciated by those skilled in the art that there are many shapes the indicating member 122 may be, and an appropriately shaped engaging member 140 must be selected for use with a particular fastener 102. Thus, the indicating member 140 may be removably connectable to the engaging axle 142 to permit interchangeability of differently shaped engaging members.

An upper end portion 149 of the engaging axle 142 is connected, via a clutch 150, to an upper end portion 139 of the drive axle 131. The clutch 150 preferably is an electromagnetic clutch, which is also connected to an encoder shaft 171 of an encoder 170. Thus the drive axle 131 and the engaging axle 142 rotate together during tightening of the fastener 102.

The apparatus 101 is provided with a device for sensing a predetermined resistance to rotation of the engaging member 140, in the form of angle or rotary encoder 170. The encoder 170 may operate by several known means including a torque-limiter with a needle or ball bearing structure or a light transmission principle. The encoder 170 is connected to an upper portion of the housing 130 and is configured to sense and measure relative rotation between the drive axle 131 and the engaging axle 142. This relative rotation occurs when a bearing structure 152 of the clutch 150 is overcome at a predetermined resistance to rotation of the engaging means 140. The angle encoder 170 is also configured to send a signal via a line 175 to a controller controlling rotation of the drive axle 131 to stop rotation thereof, once a predetermined angular twist of the engaging axle 142 relative to the drive axle 131 is achieved. This angular twist may be measured as a substantial cessation of relative rotation between the engaging axle 142 and the drive axle 131.

The apparatus 101 operates as follows. To initiate tightening of the fastener 102, the apparatus 101 is positioned such that the head 111 is received in the receiving member 134. In FIG. 1 it can be seen that the receiving member 134 is only partially engaged with the head 111 and that the engaging member 140 receives the indicating member 122 with relatively less compression of the spring 143 (as compared with the second embodiment discussed later). The apparatus 101 may sense this engagement and emit a sound or light up an LED via a limit or proximity switch. This sound or light emission would indicate to the user that the apparatus 101 is correctly engaged with the fastener 102, and that tightening can be commenced.

The drive axle 131 is then caused to rotate by way of hydraulic pressure from the ratchet mechanism 133 via the conduit 160, which via the clutch 150 effects rotation of the engaging axle 142. Rotation of the drive axle 131 causes the fastener 102 to rotate, and thus tighten. Rotation of the engaging axle 142 causes the engaging member 140 and the indicating member 122 to rotate.

Once the fastener 102 has been sufficiently tightened, the indicating member 122 is held against rotation by frictional engagement with the end face 114, which substantially prevents the indicating member 122 and thus the receiving member 140 from rotating relative to the fastener 102. However, the drive axle 131 continues to rotate relative to the engaging axle 142. This gives rise to an angular twist in the engaging axle 142, which the angular encoder 170, via the clutch 150, senses. Once a predetermined twist has been achieved, the clutch 150 slips, thereby disengaging the engaging axle 142 and the drive axle 131. The encoder 170 sends a signal through the switch 172 via the line 175 to the controller to one of slow, stop, or slow then stop rotation of the drive axle 131. In this condition the fastener 102 has been tightened to the correct, predetermined tensile load, without any requirement for the user to check the indicator member 122 at frequent intervals during tightening of the fastener 102, to ensure that the fastener 102 is not over-tightened. Indeed, apparatus 101 provides an automatic fastening operation responsive to a measurement of the substantial cessation of relative rotation between the engaging axle 142 and the drive axle 131 during the tightening operation.

In use, the ratchet mechanism 133 one of slows, stops, or slows then stops at substantially the predetermined tensile load. The receiving member 134 and engaging member 140 are supported on separate axles, drive axle 131 and engaging axle 142, respectively. The sensing device, which may be angular encoder 170, senses the predetermined resistance in one of a form of an angular twist and a torsional load in drive axle 131 and engaging axle 142. The sensing device may further sense the predetermined resistance in a form of a cessation of relative motion between drive axle 131 and engaging axle 142.

While the ratchet mechanism 133 is hydraulically driven, it may be pneumatically, electrically or manually driven. The engaging member 140 is supported at the lower end portion 148 of engaging axle 142, which extends through aperture 137 in receiving member 134. Also in apparatus 101, the engaging member 140 and the receiving member 134 are rotatable about a common axis, dependent of each other and in the same direction. The engaging member 140 is rotationally fixed relative to the receiving member 134 via the clutch 150, which is configured to slip at substantially the predetermined resistance at substantially the predetermined tensile load.

Referring to FIG. 2, this shows a second embodiment of an apparatus 201 for tightening a load indicating fastener 102. Components of apparatus 201 substantially in common with apparatus 101 of FIG. 1 have been given the same reference numeral, but with the addition of 100. A controller (not shown) allows a user to choose between at least the first 101 and second 201 embodiments of the apparatus of the present invention.

The apparatus 201 may be used to fasten members together, such as flat members 205 and 206, which are fastened in face-to-face relation by a fastener 202, commonly known in the art as a ‘stud and nut combination’. A first nut 211 of the fastener 202 is adjacent an exposed face of the flat member 205. A second nut 216 of the fastener 202 is adjacent an exposed face of the flat member 206. The nuts 211 and 216 may act on flat members 205 and 206 via washers.

Generally, the fastener 202 is of the kind having at least a partially hollow stud 210; a gauge pin 220 in the stud 210; and an indicating member 222 rotatably supported on the gauge pin 220, the indicating member 222 being rotatable when the fastener 202 is unstressed and substantially non-rotatable when the fastener 202 is subjected to a predetermined tensile load.

Specifically, the stud 210 has an axial bore 212 extending from an end face 217 of the stud 210 towards an end portion 218 of the stud 210. The gauge pin 220 is positioned in the axial bore 212 and connected to the stud 210 by threaded lower portion 221 inside the axial bore 212 (towards a lower portion 215 thereof). A part 224 of an upper portion 223 of the gauge pin 220 protrudes outwards beyond the end face 217. The protruding part 224 rotatably supports the indicating member 222. The indicating member 222 is arranged such that it is free to rotate when the stud 210 is unstressed. When the stud 210 is subjected to the predetermined tensile load (i.e. once the nut 211 has been tightened to a required load) the indicating member 222 is held against rotation by contact with the end face 217 as a result of the stud 210 elongating under the tensional load. Thus, the indicating member 222 indicates to a user whether the fastener 202 has been fully tightened.

An upper end portion 249 of the engaging axle 242 is connected, via a clutch 280, to an upper portion of the housing 230. The clutch 280 preferably is an electromagnetic clutch, which is also connected to an encoder 282. Thus the drive axle 231 is not connected to the engaging axle 242. The engaging axle 242 is instead free from rotation with the drive axle 231 during tightening of the fastener 202.

The encoder 282 may operate by several known means including a torque-limiter with a needle or ball bearing structure or a light transmission principle. The encoder 282 is connected to an upper portion of the housing 230 and is configured to sense and measure relative rotation between the drive axle 231 and the engaging axle 242. This relative rotation occurs when a bearing structure of the clutch 280 is overcome at a predetermined resistance to rotation of the engaging member 240. The angle encoder 282 is also configured to send a signal via a line 275 to the controller controlling rotation of the drive axle 231 to stop rotation thereof, once a predetermined angular twist of the engaging axle 242 relative to the drive axle 231 is achieved. This angular twist may be measured as a substantial commencement of relative rotation between the engaging axle 242 and the drive axle 231.

The apparatus 201 operates as follows. To initiate tightening of the fastener 202, the apparatus 201 is positioned such that the second nut 211 is received in the receiving member 234. In this condition the engaging member 240 receives the indicating member 222, with relatively more compression of the spring 243 than in the first embodiment of the apparatus 101.

The drive axle 231 is caused to rotate similar to the apparatus 101 which causes the nut 211 to rotate, and thus tighten and elongate the stud 210. The engaging axle 242, engaging member 240 and indicating member 222 are relatively still.

Once the stud 210 has been sufficiently tightened by nut 211, the indicating member 222 is held against the stud 210 by frictional engagement with the end face 217. As a result, the clutch 280 slips thereby engaging drive axle 231 and engaging axle 242. The engaging member 240 then begins to rotate with the engaging axle 242, which is sensed by the angle and/or rotary encoder 282. The encoder 282 sends a signal through the switch 284 via the line 275 to the controller to one of slow, stop, or slow then stop rotation of the drive axle 231. In this condition the fastener 202 has been tightened to the correct, predetermined tensile load, without any requirement for the user to check the indicating member 222 at frequent intervals during tightening of the fastener 202, to ensure that the fastener 202 is not over-tightened. Indeed, the apparatus 201 provides an automatic fastening operation responsive to a measurement of the substantial commencement of relative rotation between the engaging axle 242 and the drive axle 231 during the tightening operation.

Contrasted with apparatus 101 of FIG. 1, apparatus 201 has the sensing device, an angular encoder 282, for sensing the predetermined resistance to rotation of engaging member 240 at substantially the predetermined tensile load. As fastener 202 is a stud and nut combination, engaging member 240 is further configured such that, in use, it is unfixed rotationally relative to fastener 202. The sensing device may sense the predetermined resistance in a form of a commencement of relative motion between the drive axle 231 and the engaging axle 242. The engaging member 240 and the receiving member 234 are rotatable about a common axis, independent of each other and in the same direction until substantially the predetermined tensile load. The engaging member 240 is rotationally unfixed relative to the receiving member 234 via the clutch 280, which is configured to slip and engage the drive axle 231 and the engaging axle 242 at substantially the predetermined tensile load.

It should be noted that that the apparatus 201 may be used for tightening the fastener 101. Likewise, the apparatus 202 may be used for tightening the fastener 201.

In a third embodiment of the apparatus of the present invention (not shown in the figures) the apparatus may include a motor, current detecting means and rotation angle detection means. A current detecting means (e.g., an ammeter) for detecting a current flowing to an electric motor and a rotation angle detecting means (e.g. a rotary encoder) for detecting a relative rotation angle of an engaging axis to a drive axis may be used in a third system of the present application. An upper end of the engaging axle is connected via an electromagnetic clutch and gearbox, to the electric motor and the rotary encoder with power to these components being provided along power lines.

The drive axle is caused to rotate via hydraulic pressure. At the same time, or shortly afterwards, the engaging axle and thus engaging member is caused to rotate at a low speed (in either the same or the opposite direction to the drive axle) by the motor. Rotation of the drive axle causes the fastener to rotate, and thus tighten it. Rotation of the engaging axle by the motor causes the engaging member and the indicating member to rotate.

Once the fastener has been sufficiently tightened, the indicating member is held against rotation by frictional engagement with the fastener, which substantially restricts the indicating member from rotating relative to the fastener. This substantially restricts the engaging axle from rotating which causes the motor to draw increased power. The increased power in the motor gives rise to a torsional load which causes the electromagnetic clutch to slip, thus flipping a switch. The electromagnetic clutch is calibrated such that it will slip once it experiences a predetermined torsional load, which corresponds to a desired tensional load in the fastener. This slippage is sensed by the rotary encoder, which sends a signal through a controller to the ratchet mechanism and the motor to one of slow, stop, or slow then stop rotation of the drive axle and the engaging axle. In this condition the fastener has been tightened to the correct, predetermined tensile load, without any requirement for the user to check the indicator member at frequent intervals during tightening of the fastener, to ensure that the fastener is not over-tightened. Indeed, this system provides an automatic fastening operation responsive to a measurement of substantial cessation of relative rotation between the engaging axle and the drive axle during the tightening operation.

The mechanical clutch utilised in the present invention may have a pair of opposing clutch plates, and biasing means (e.g., a compression spring) for pressing one of the pair of clutch plates toward the other. When the angular twist or torsional load acting on the engaging shaft is less than the predetermined resistance, the clutch plates are mechanically engaged and the drive axle continues to rotate by way of hydraulic pressure from the ratchet mechanism. On the other hand, when the twist or load acting on the engaging axle reaches or exceeds the predetermined resistance value, one of the clutch plates idles relative to the other clutch plate, and hence hydraulic pressure to drive axle is shut off. Note that the pressing force of the biasing means, or alternatively bearing means, is preferably adjustable to the predetermined value at which the clutch mechanism is activated. Note that other types of mechanical or electromagnetic clutch mechanisms may be used in a system of the present application.

The apparatus in accordance with the present invention may be controlled by a control unit including a microcomputer. The microcomputer may include a CPU, a ROM, a RAM and an I/O integrated on a single chip. The ROM of the microcomputer stores a control program for automatically halting the ratchet mechanism (in the case of an apparatus like the apparatus 101, 201) and for automatically halting the ratchet mechanism and the driving of the motor (in the case of a system like the third system). The control unit may further include a memory in addition to the microcomputer. The memory may store: a preset range of resistance value of the indicating member of the fastener; a preset range of resistance values for the activation of the clutches; a preset relative rotation angle range of the engaging shaft to the drive shaft for the encoders; and/or a preset range of currents corresponding to the resistance values of the indicating members for the motor; etc.

An hydraulic pump switch, the limit or proximity switch, the first and the second clutch activation detection switches, and the first and the second rotation angle detection sensors may be connected to and signals input into the microcomputer. A power supply is connected to the microcomputer via a power circuit unit. The power from the supply is converted into power for the microcomputer by the power circuit unit, and supplied to the microcomputer.

In the case of the third embodiment, the power supply is connected to and provides current to rotate the motor via, perhaps, a motor driving semiconductor switch. Note that the motor may be a DC motor and the semiconductor switch may be PWM-controlled by the microcomputer to convert a direct current from the power supply into a three-phase current. The semiconductor switch may be connected to the power supply via a current detection unit. The current detection unit detects the current flowing to the motor via the semiconductor switch. A current value detected by the current detection unit is input into the microcomputer. Once the predetermined torsional load and current value are reached and the rotary encoder sends a signal to the motor through the controller to one of slow, stop, or slow then stop rotation of the drive axle and the engaging axle.

Note that an operation manager may set and store in the memory: a preset range of resistance values of the indicating member of the fastener; a preset range of resistance values for the activation of the clutches; a preset relative rotation angle range of the engaging shaft to the drive shaft for the encoders; and/or a preset range of currents corresponding to the resistance values of the indicating members for the motor. These indicator values, in accordance with the automatic tightening operation, may be set and stored by manipulating an external input apparatus (e.g., a personal computer) connected by wire or wirelessly to the apparatus. These indicator values may be determined through testing of the systems and storing each resulting value during each tightening operation. Then, a statistically processed value such as an average value or a preset range of the stored indicator values may be set and stored in the memory.

Referring to the discussion related to the third embodiment, a testing means/apparatus of the present invention (not shown) for determining whether the fasteners have reached and/or maintained the predetermined tensile load, may include: an engaging member, rotatably supported in the apparatus, and being configured such that, in use, it is fixed rotationally relative to the indicating member; a device for effecting rotation of the engaging member; and a device for sensing a predetermined resistance to rotation of the engaging member.

It should be appreciated that the testing apparatus may be a stand-alone apparatus with fewer components than the tightening apparatus of the present invention. Alternatively, the testing apparatus may be a part of the tightening apparatus either separate from or integral with it. Where the testing apparatus is integral with the tightening apparatus, a user may select whether to perform a tightening or testing operation

A management apparatus/system for managing tightening, testing and managing operations of fasteners using means/apparatus for tightening, testing and managing may be provided. For example, the management system may include a tightening, a testing and a managing apparatus (for example, a personal computer) connected communicably to each other. Alternatively, the management system may include a plurality of tightening, testing and managing apparatus. The management system may include means/apparatus for determining (a microcomputer, microprocessor, or the like) whether or not the predetermined indicator values have been reached. The management system may include means for memory storage of operation management information. The communicating means of the tightening, testing and managing apparatus transmits a determination result when an indicator value is reached determined by the determining means. The management system, in the case of a tightening operation, may then transmit a signal to either slow, stop or slow then stop rotation of the fastener. The management system, in the case of a testing operation, may then transmit a signal to the tightening apparatus to tighten or re-tighten the fastener. The memory of the management system stores the determination result transmitted from the communicating means of the tightening, testing and managing apparatus. It should be appreciated that a plurality of management tasks may be performed, including: the tightening of a fastener; the simultaneous tightening of a plurality of fasteners; the testing of a fastener; the simultaneous testing of a plurality of fasteners; determining the normality of tightening of the fasteners; storing of data of tightening and testing operations over a range of operation periods; and determining the extent of wear of components of the tightening and testing apparatus; etc.

A tightening apparatus for simultaneously tightening a plurality of fasteners may include a plurality of tightening apparatus engaged and/or attached to each other by a reaction adaptor and/or a reaction hub, each having a drive axle. The reaction adaptor includes a first force-transmitting element, when engaged with the tightening apparatus being rotatable about the drive axle; and a second force-transmitting element, when engaged with the first element, being extensible and retractable along at least a distal portion of the first element. The second element, when engaged with a second tightening apparatus, is rotatable about the drive axle of the second tightening apparatus. Note that both the first and the second elements extend substantially perpendicular from their respective tightening apparatus drive axles. The reaction adaptor allows for simultaneous use of two tightening apparatus where as a reaction hub allows for simultaneous use of three or more tightening apparatus to tighten three or more fasteners.

It should be appreciated that the apparatus of the present application may be used with many different types of load indicating fasteners having rotatable indicating members to indicate when the fastener experiences a predetermined tensile load. Several examples of these fasteners are disclosed in U.S. Pat. No. 4,525,114 (equivalent to EP 0049537) and U.S. Pat. No. 5,222,849 (equivalent to EP 0626043), incorporated by reference herein, and include screws, studs, bolts, stud and nut combinations, and bolt and nut combinations. Additional geometries and configurations of fasteners amenable for use with rotatable indicating members are well known in the art, and may include: fasteners having two or more bores of varying dimensions and geometries, including recessed portions; gauge pins secured in the shank by threads, adhesives, pressing, and other means; gauge pins secured in upper, lower, and middle portions of the shank; and indicating members protruding from, flush with, and recessed from an end face of the fastener, the indicating members including cap, disc, cup, tool engagement means, feet, lightening hole, and other rotatable structures.

Generally, such fasteners may have: a shank; measuring means for measuring the elongation of the shank during tightening of the fastener; and either a head connected to the shank, or alternatively, a nut which is threadedly engageable with the shank. More specifically, such fasteners may have: at least a partially hollow shank; a gauge pin in the shank; and an indicating member rotatably supported on the gauge pin, the indicating member being rotatable when the fastener is unstressed and substantially non-rotatable when the fastener/shank is subjected to the predetermined tensile load/elongation. Furthermore, such fasteners may have: an axial bore extending from an end face either partially to or completely to another end face of the shank; the gauge pin positioned substantially in the bore, connected to the shank, and either protruding from, flush with or recessed from one of the end faces; the indicating member in contact with only the gauge pin when the fastener is unstressed and in contact with the gauge pin and a part of the fastener or apparatus when the fastener/shank is subjected to the predetermined tensile load/elongation.

It should also be noted that appropriately shaped engaging members must be selected depending on the mix of fastener characteristics chosen by a user. The engaging member may receive the indicating member either without, with or within the shank. For example, the user may choose: a screw with a recess in its head; a bore in the recess; a gauge pin flush with the bottom of the recess, the gauge pin having a flat head screwdriver engagement. In such a case, the engaging member would not be a cup structure, but that of a flat head screwdriver.

It should be appreciated that the systems of the present application may be made from any suitable material such as aluminum, steel, other metals, metallic alloys, and/or other alloys including non-metals.

It should be appreciated that a system of the present application may include the fastener, tightening apparatus, testing apparatus and managing apparatus.

Generally, a tightening apparatus may have: means for receiving the head connected to or for receiving a nut engageable with the shank; means for effecting rotation of the receiving means; means for engaging the apparatus with a part of the measuring means; and means for sensing when the shank reaches the predetermined tensile load/elongation. More specifically, such tightening apparatus may have: a receiving member rotatably supported in the apparatus, for receiving a portion of the fastener; a device for effecting rotation of the receiving member; an engaging member, rotatably supported in the apparatus, and being configured such that, in use, it is fixed rotationally relative to the indicating member; and a sensing device for sensing a predetermined resistance to rotation of the engaging member. The device for effecting rotation of the receiving member either slows, stops or slows then stops at substantially the predetermined resistance at substantially the predetermined tensile load/elongation. The device for effecting rotation of the receiving member may be one of pneumatically, electrically, hydraulically and manually driven.

The receiving and engaging members may be supported on separate axles, and the sensing device may sense the predetermined resistance/tensile load/elongation as either an angular twist, a torsional load, a commencement of, a cessation of or a commencement of and a cessation of relative motion in the axles. The receiving and engaging members may be rotatable about a common axis, either independently or dependently of each other, and in either the same or opposite directions. Where the receiving and engaging members are rotatable independent of each other, a device for effecting rotation of the engaging member, such as a motor, may be provided in the apparatus. The engaging member may be either rotationally fixed or unfixed relative to the receiving member via a clutch, where the clutch is configured to slip at substantially the predetermined resistance at substantially the predetermined tensile load/elongation. The engaging member may be supported at an end of an axle which extends through an aperture in the receiving member.

An apparatus for managing the fasteners may include: means for tightening fasteners, means for testing the fasteners and means for managing the tightening and testing means and/or the fasteners. The means for tightening, testing and managing may have means for communicating with each other. The means for tightening may also include means for sensing a predetermined indicator value. Further, the means for managing may also include means for determining whether a predetermined indicator value has been reached and means for memory storage of operation management information.

An illustrative example of a method of automatically tightening a fastener with a tightening apparatus of the present application includes the following steps. The fastener is provided about a tightening member. The tightening apparatus is provided about the fastener. The indicating member of the fastener is engaged with the engaging member of the tightening apparatus. Next, the fastener is rotated by the tightening apparatus. The sensing device senses for a predetermined resistance to rotation of the engaging member at substantially the predetermined tensile load/elongation. The tightening apparatus either slows, stops, or slows then stops the fastener rotation.

An illustrative example of a method of automatically testing a fastener with a testing apparatus of the present application includes the following steps. The indicating member of the fastener is engaged with the engaging member of the testing apparatus. Next, a device for effecting rotation of the engaging member is activated. The sensing device senses for a predetermined resistance to rotation of the engaging member at substantially the predetermined tensile load/elongation. The testing apparatus either slows, stops, or slows then stops the attempted rotation of the engaging member.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. An apparatus for tightening a threaded fastener comprising:
a shank with an axial bore;
a gauge pin positioned in the bore and connected to the shank, a part of the gauge pin either protruding from, flush with or recessed from an end face of the fastener; and
an indicating member rotatably supported on the either protruding, flush or recessed part of the gauge pin, the indicating member being arranged such that it is free to rotate when the fastener is unstressed but when the fastener is subjected to a predetermined tensile load the indicating member is held against rotation, wherein the fastener has either a head connected to the shank or, alternatively, has a nut which is threadedly engageable with the shank;
the apparatus including:
a receiving member, rotatably supported in the apparatus, for receiving the head connected to or for receiving a nut engageable with the shank;
a device for effecting rotation of the receiving member;
an engaging member, rotatably supported in the apparatus, and being configured such that, in use, it is fixed rotationally relative to the indicating member, and an additional device for effecting rotation of the engaging member;
wherein the apparatus includes a device for sensing a predetermined resistance to rotation of the engaging member, and such that the engaging member and receiving member are rotatable independently of each other about a common axis.

2. An apparatus according to claim 1 wherein the receiving member is supported on an axle, the engaging member is supported on an axle, the axle of the receiving member and the axle of the engaging member being coaxial, and the device for sensing a predetermined resistance to rotation of the engaging member senses either a commencement of relative motion, a cessation of relative motion or both a commencement of and a cessation of relative motion between the axle of the receiving member and the axle of the engaging member.

3. An apparatus according to claim 1 wherein the engaging member is supported on an axle, and the device for sensing a predetermined resistance to rotation of the engaging member senses either an angular twist in said axle or a torsional load in said axle.

4. (canceled)

5. An apparatus according to claim 1 including a clutch which is configured to slip when the engaging member experiences the predetermined resistance to rotation.

6. An apparatus according to claim 1 wherein the engaging member and receiving member are rotatable independently or dependently of each other about a common axis.

7. (canceled)

8. An apparatus according to claim 1 wherein the engaging member and receiving member are rotatable in the same or opposite directions.

9. An apparatus according to claim 1 wherein the engaging member is rotationally fixed relative to the receiving member via a clutch, said clutch being configured to slip when the engaging member experiences a predetermined resistance to rotation.

10-22. (canceled)

23. An apparatus for tightening a threaded fastener comprising:
a shank;
means for measuring the elongation of the shank during tightening of the fastener;
wherein the fastener has either a head connected to the shank, or alternatively, has a nut which is threadedly engageable with the shank;
the apparatus including:
means for receiving the head connected to or for receiving a nut engageable with the shank;
means for effecting rotation of the receiving means;
means for engaging the apparatus with part of the measuring means;
means for effecting rotation of the engaging means, such that the engaging means and receiving means are rotatable independently of each other about a common axis; and
means for sensing when the shank reaches the predetermined elongation.

24. An apparatus according to claim 23 wherein the measuring means of the shank includes a gauge pin positioned in an axial bore of and connected to the shank, a part of the gauge pin either protruding from, flush with or recessed from an end face of the shank, and an indicating member rotatably supported on the either protruding, flush or recessed part of the gauge pin, the indicating member being arranged such that it is free to rotate when the shank is unstressed but when the shank has reached a predetermined elongation the indicating member is held against rotation.

25. An apparatus according to claim 23 wherein the engaging means being rotatably supported in the apparatus and being configured such that, in use, it is fixed rotationally relative to part of the measuring means.

26. An apparatus according to claim 23, wherein the receiving means is supported on an axle, the engaging means is supported on an axle, the axle of the receiving means and the axle of the engaging means being coaxial, and the sensing means for sensing when the shank reaches the predetermined elongation senses either a commencement of relative motion, a cessation of relative motion or both a commencement of and a cessation of relative motion between the axle of the receiving means and the axle of the engaging means.

27. An apparatus according to claim 23, wherein the engaging means is supported on an axle, and the sensing means for sensing when the shank reaches the predetermined elongation senses either an angular twist in said axle or a torsional load in said axle.

28. (canceled)

29. An apparatus according to claim 23, including a means for clutching which is configured to slip when the shank reaches the predetermined elongation.

30-31. (canceled)

32. An apparatus according to claim 23, wherein the engaging means and receiving means are rotatable in the same or opposite directions.

33. An apparatus according to claim 23, wherein the engaging means is rotationally fixed relative to the receiving means via a means for clutching, said clutching means being configured to slip when the engaging member experiences a predetermined resistance to rotation.

34-38. (canceled)

39. An apparatus for managing a threaded fastener comprising:
a shank with an axial bore;
a gauge pin positioned in the bore and connected to the shank, a part of the gauge pin either protruding from, flush with or recessed from an end face of the fastener;
an indicating member rotatably supported on the either protruding, flush or recessed part of the gauge pin, the indicating member being arranged such that it is free to rotate when the fastener is unstressed but when the fastener is subjected to a predetermined tensile load the indicating member is held against rotation by contact with a part of the fastener, wherein the fastener has either a head connected to the shank or, alternatively, has a nut which is threadedly engageable with the shank;
means for tightening the fastener; and
means for managing the tightening means; wherein the tightening means includes:—
a receiving member, rotatably supported in the tightening means, for receiving the head connected to or for receiving a nut engageable with the shank;
a device for effecting rotation of the receiving member;
an engaging member, rotatably supported in the tightening means, and being configured such that, in use, it is fixed rotationally relative to the indicating member;
a device for sensing a predetermined indicator value;
means for communicating with the apparatus; and
an additional device for effecting rotation of the engaging member, such that the engaging member and receiving member are rotatable independently of each other about a common axis.

40. (canceled)

41. An apparatus according to claim 39 wherein the managing means includes:
means for communicating with the tightening means;
means for determining whether a predetermined indicator value has been reached; and
means for memory storage of operation management information.

42. An apparatus according to claim 39, including means for testing the fastener including:
an engaging member, rotatably supported in the apparatus, and being configured such that, in use, it is fixed rotationally relative to the indicating member;
a device for effecting rotation of the engaging member; and
a device for sensing a predetermined resistance to rotation of the engaging member; and
means for communicating with the apparatus.

43-46. (canceled)
